(19) United States
(12) Patent Application Publication
(10) Pub. No.: US 2026/0105295 A1
(43) Pub. Date: Apr. 16, 2026

(54) ADAPTIVE TRANSFORMATION ORTHOGONAL MODELING SYSTEM FOR DYNAMIC FEATURE ENRICHMENT FOR PROACTIVE OPTIMIZATION OF NETWORK PERFORMANCE

(71) Applicant: VERIZON PATENT AND LICENSING INC., Basking Ridge, NJ (US)

(72) Inventors: Praveenkumar BALAKRISHNAN, Kanchipuram (IN); Karthik SADHASIVAM, Kumbakonam (IN); Bharathi RAVINDRAN, Chennai (IN)

(73) Assignee: VERIZON PATENT AND LICENSING INC., Basking Ridge, NJ (US)

(21) Appl. No.: 18/912,678

(22) Filed: Oct. 11, 2024

(51) Int. Cl. G06N 3/08; G06N 3/04

(52) U.S. Cl. CPC G06N 3/08; G06N 3/04

(57) ABSTRACT

A system may receive a dataset comprising a plurality of instances. A system may apply a gating layer to each instance to generate a first set of instances and second set of instances. A system may generate synthetic features for the first set of instances using a feature enrichment process to generate enriched instances and processing the enriched instances using a first adaptive intelligence layer. A system may process the second set of instances using a second adaptive intelligence layer. A system may combine outputs from the first adaptive intelligence layer and the second adaptive intelligence layer to generate a combined dataset. A system may generate a predictive output based on the combined dataset.

### BACKGROUND

In recent years, the field of machine learning has seen tremendous growth and application across various domains, from healthcare to telecommunications, among others. As the complexity and volume of data continue to increase, so do the technical challenges of designing and training accurate and efficient predictive models. One of the key technical difficulties faced by data scientists and machine learning engineers is the variability in feature quality and relevance across different subsets of data.

Traditional machine learning approaches often struggle with datasets where the predictive power of features varies significantly across different segments of a population, or under different conditions. This heterogeneity in feature effectiveness can lead to suboptimal model performance, as a single set of features may not be equally informative for all instances. Furthermore, the process of feature engineering to improve model accuracy, is often manual and time-consuming, requiring significant domain expertise.

In network performance optimization, the variability of available data across different network elements presents a unique challenge. Some network components may have abundant associated data, while others have limited information, impacting the accuracy of performance prediction models across different network segments.

### BRIEF DESCRIPTION OF THE DRAWINGS

FIG. 1 is a block diagram of an adaptive transformation orthogonal modeling system according to some of the disclosed embodiments.

FIG. 2 is a flow diagram illustrating a method for enriching feature data using the adaptive transformation orthogonal modeling system.

FIG. 3 is a flow diagram illustrating training phase exploration method of the adaptive transformation orthogonal modeling system.

FIG. 4 is a flow diagram illustrating training phase exploitation and inferencing method of the adaptive transformation orthogonal modeling system.

FIG. 5 is a flow diagram illustrating the feature enrichment process within the adaptive transformation orthogonal modeling system.

FIG. 6 is a block diagram of a computing device according to some embodiments of the disclosure.

### DETAILED DESCRIPTION

In recognition of the deficiencies in the art, the present disclosure is directed to adaptive and automated approaches to feature selection and generation that can handle the complexities of real-world, heterogeneous datasets while maintaining high predictive performance across diverse data instances.

The absence of comprehensive network monitoring systems, coupled with the siloed nature of existing network data, presents a significant obstacle to holistic system analysis. The lack of granular data capture mechanisms further exacerbates this challenge. Furthermore, inconsistencies in data formats and definitions across disparate network elements impede data aggregation efforts. Consequently, the availability and reliability of network attributes are compromised, hindering effective network performance optimization. This system aims to address these limitations by enhancing and enriching the feature set accessible for network performance optimization.

The disclosed system presents techniques for handling heterogeneous datasets in machine learning tasks, such as network monitoring and optimization. The system employs a gating layer that dynamically routes input instances through either a standard processing pathway (green) or a feature enrichment pathway (gray). This adaptive routing allows the system to apply additional feature engineering only when necessary, optimizing computational resources and improving overall predictive performance.

For instances routed through the gray pathway, the system utilizes a feature enrichment process that can generate synthetic features that are both orthogonal to the original features and relevant to the prediction task. The feature generation is guided by a dual-objective loss function that balances feature novelty with predictive power. Both the original and enriched feature sets are then processed through adaptive intelligence layers, which employ deep learning techniques to extract high-level representations and generate predictions.

The system's architecture allows for efficient handling of datasets where feature quality and relevance vary across different subsets of data. By dynamically enriching features for challenging instances and maintaining a streamlined process for well-represented instances, the system can achieve improved prediction accuracy across a wide range of applications and data types. This adaptive and modular approach represents a significant advancement in addressing the challenges of variable feature quality in machine learning tasks.

The techniques described herein relate to a method for processing datasets with multiple instances. This method may include using a gating layer to categorize instances into two sets. For one set, synthetic features may be generated through a feature enrichment process, creating enriched instances that are then processed by a first adaptive intelligence layer. The other set may be processed by a second adaptive intelligence layer without enrichment. The outputs from both layers may then be combined to create a unified dataset, which is used to generate a predictive output.

The gating layer in this method can be trained through an exploration phase. This phase can include setting an epoch count, classifying features into enriched and non-enriched sets, and then updating the gating layer based on these classifications. When processing instances, both adaptive intelligence layers can follow a similar procedure. They can receive input features, apply a series of deep learning layers to these features, and then generate an output. For binary classification tasks, this output can be produced using a sigmoid function, while for multi-class classification, a softmax function is employed.

The process of generating synthetic features can be iterative. It can use a generative model and evaluates the created features using a combined loss function. This function measures how different the synthetic features are from the original ones (orthogonality) and how relevant they are to the target variable. The generative model can be updated repeatedly until it meets a convergence criterion. The combined loss function used in feature generation has two components. One measures the correlation between original and synthetic features, while the other measures prediction error using the synthetic features. These components are weighted to balance their influence.

Throughout its operation, the gating layer can be dynamically adjusted. This adjustment is based on how well instances are processed with and without feature enrichment. The gating layer itself can be implemented as a binary classifier. Its parameters are updated through backpropagation, taking into account the performance difference between the two adaptive intelligence layers.

Methods, systems, devices, and computer-readable media for performing the above functions are described next herein in more detail.

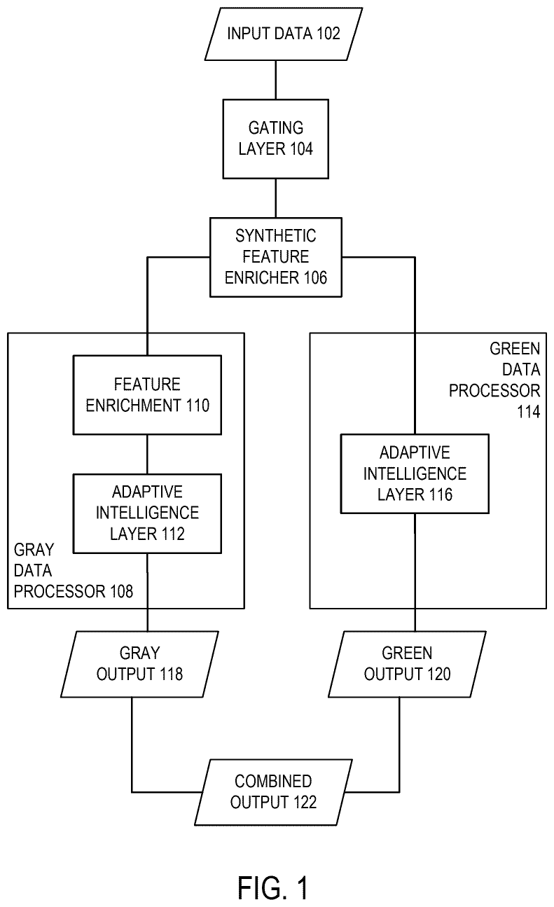

FIG. 1 is a block diagram of an adaptive transformation orthogonal modeling system according to some of the disclosed embodiments. In some implementations, the system 100 is designed to address the challenge of insufficient feature sets in AI models, particularly in scenarios where available features are inadequate to fully explain the target variable, as described in more detail herein.

As illustrated, the system 100 includes an input data 102, which can represent the initial dataset used for training or inference. The input data 102 can include a set of features and corresponding target variables.

In the context of network performance prediction and optimization tasks, the input data 102 can encompass a wide range of network-specific features and metrics. These may include fundamental network performance indicators such as latency (e.g., round-trip time, one-way delay), throughput (e.g., bits per second, packets per second), and packet loss rates. Device-specific attributes could also be part of the input data, such as router buffer sizes, link capacities, or switch forwarding rates. The dataset might also include temporal features like time of day or day of week to capture traffic patterns, and topological information describing the network structure. More advanced metrics might involve jitter (variation in packet delay), Mean Opinion Score (MOS) for voice quality, or application-specific performance indicators. In some cases, the input data could also include external factors that impact network performance, such as weather conditions for wireless networks or concurrent user counts for shared resources. While network data is used in the description as an example of input data 102, features can include various attributes or characteristics relevant to other prediction tasks, such as customer demographics, environmental sensor readings, manufacturing process parameters, or any other domain-specific information.

The input data 102 is fed into a gating layer 104. In some implementations, the gating layer 104 can perform adaptive target routing of the input data 102, as described in more detail herein. In some implementations, gating layer 104 can classify incoming data instances into two (or more) categories. As used herein, two categories are described although the disclosure is not limited exclusively to a binary classification, and more categories may be added as needed. As used herein, the two categories are referred to as “green” and “gray.” In the following description, green data can represent instances where the existing feature set is deemed sufficient for accurate prediction, while gray areas can indicate instances where the current features are insufficient and require enhancement. The terminology “green” and “gray” is used for simplicity and other labels may be used as desired.

In the context of network performance data, “green” data may represent network elements or connections with comprehensive, reliable, and up-to-date performance metrics. For example, a core router in a data center with advanced monitoring capabilities could provide a rich set of features including detailed traffic statistics, queue lengths, and processor utilization, making it a “green” instance. On the other hand, “gray” data might come from network edges, legacy devices, or areas with limited monitoring infrastructure. An example of a “gray” instance could be a router that only reports basic connectivity status and aggregate throughput, lacking granular performance metrics. Similarly, data from intermittently connected IoT devices or mobile network elements might be classified as “gray” due to the sporadic nature of their reporting and the limited set of metrics they provide.

The gating layer 104 can employ a learning mechanism to make the foregoing classification. During the initial training phase, the gating layer 104 can process input data and learn to distinguish between green and gray areas. This learning process can continue for a predetermined number of epochs, which is a hyperparameter of the system that can be tuned based on the specific dataset and problem domain. In some implementations, the gating layer 104 can be implemented as a neural network, decision tree, or another suitable machine learning model capable of binary classification. Its architecture can be designed to effectively capture the relevant features that determine whether an instance requires feature enrichment. As the gating layer 104 processes more data during the training phase, it refines its decision-making criteria, gradually improving its ability to accurately route instances to the appropriate pathway. The learning process can involve techniques such as backpropagation for neural network implementations, where the gating layer's parameters are updated based on the performance difference between the green and gray pathways for each instance. The gating layer 104 may also incorporate regularization techniques to prevent overfitting and ensure generalization to unseen data. In some implementations, the epoch count can be determined through cross-validation or other model selection techniques specific to the dataset and task at hand.

For data instances classified as belonging to the gray area, the system forwards the gray input data to a synthetic feature enricher 106. In some implementations, synthetic feature enricher 106 can be responsible for generating additional, synthetic features to augment the original feature set. The synthetic feature enricher 106 can create new features that are both informative and orthogonal to the existing features. In this context, orthogonality refers to the statistical independence or lack of correlation between the newly generated features and the original features, ensuring that the synthetic features provide genuinely new information rather than redundant or highly correlated variations of the existing features.

In a network environment, these synthetic features may include estimated packet loss rates derived from throughput and latency measurements, inferred link utilization based on traffic patterns and known link capacities, or predicted peak hour performance metrics generated from limited time-series data. The synthetic feature enricher may also create synthetic quality of service (QoS) indicators by combining multiple lower-level metrics, or estimate end-to-end performance characteristics for paths where only partial route information is available.

In some implementations, the synthetic feature enricher 106 employs a generative network that takes the original features (X) and a noise component as inputs. The generative function can be represented as G(X, Noise), where G denotes the generative network. The inclusion of a noise component helps in creating diverse and non-deterministic synthetic features. The inclusion of a noise component helps in creating diverse and non-deterministic synthetic features, similar to approaches taken in generative adversarial networks (GANs) and variational autoencoders (VAEs), where noise injection is used to introduce variability in the generated outputs. The noise component allows the generative network to explore a wider range of potential synthetic features, potentially capturing subtle patterns or interactions that may not be immediately apparent in the original feature set. Moreover, the stochastic nature of the noise input can aid in preventing the generative network from simply learning to reproduce the original features.

The output of the synthetic feature enricher 106 is then passed to a gray data processor 108. Within this processor, the enriched data undergoes further processing through two stages: feature enrichment 110 and an adaptive intelligence layer 112.

In some implementations, the feature enrichment 110 focuses on optimizing the newly generated synthetic features. This optimization is guided by two objectives, which are encoded in the loss function used to train the synthetic feature enricher. The first objective is orthogonality, where the system can aim to ensure that the synthetic features are as uncorrelated as possible with the original features. This can be achieved through a correlation term in the loss function, represented as Corr(X, G(X, Noise)). By minimizing this correlation, the system encourages the creation of features that capture new, complementary information not present in the original feature set. The second objective is target relevance. While maintaining orthogonality, the synthetic features should also be relevant to predicting the target variable. This can be enforced through an additional term in the loss function, typically a measure of prediction error such as cross-entropy or mean squared error, depending on the nature of the prediction task.

The combined loss function for the gray area can be expressed as:

$${L}_{Gray} = {λ}_{1} * Corr ( X , G ( X , Noise ) ) + {λ}_{2} * H ( p , q ) ,$$

where λ₁ and λ₂ are hyperparameters that control the balance between orthogonality and target relevance, and H(p, q) represents the prediction error (e.g., cross-entropy between predicted probabilities p and true labels q).

Following feature enrichment, the data passes through the adaptive intelligence layer 112. This layer consists of a set of deep learning components designed to capture patterns in the enriched feature space. In some implementations, the adaptive intelligence layer can include multiple dense or convolutional layers, depending on the nature of the input data. In some implementations, the adaptive intelligence layer 112 can also incorporate a mixture of experts (MoE) component, which allows the model to learn specialized sub-networks for different types of inputs. In some implementations, the adaptive intelligence layer 112 can utilize activation functions such as ReLU (Rectified Linear Unit) for intermediate layers and can employ dropout or other regularization techniques to prevent overfitting.

In some implementations, the adaptive intelligence layer 112 can learn complex relationships between various network metrics, both original and synthetic. For instance, it can identify patterns in how different types of network traffic affect latency and throughput across various network segments. The mixture of experts component could specialize in different aspects of network behavior, such as one expert focusing on core network performance, another on edge device behavior, and a third on application-layer performance. This layered approach allows the system to capture both broad network-wide patterns and specific, localized behaviors that might be unique to certain network elements or configurations.

The ultimate output of the adaptive intelligence layer 112 for the gray data is represented as the gray output 118.

Concurrently, the data instances classified as green by the gating layer 104 are processed through a green data processor 114. This processor contains adaptive intelligence layer 116, which is structurally similar to the one in the gray data processor but may have different learned parameters. Details of the adaptive intelligence layer 116 are thus not repeated herein and reference is made to adaptive intelligence layer 112. As illustrated, the green data processor 114 does not include a feature enrichment stage, as the original features are deemed sufficient for these instances. The output of the green data processor is represented as the green output 120.

In some implementations, the adaptive intelligence layer 112 (and similarly, the adaptive intelligence layer 116 in the green data processor 114) processes instances through several steps. First, it receives input features, which for the gray pathway are the original features combined with the synthetic features produced by the feature enrichment process. The layer then applies a series of deep learning layers to these input features. These may include multiple dense or convolutional layers, depending on the nature of the input data. The layer typically utilizes activation functions such as ReLU for intermediate layers. Finally, the adaptive intelligence layer generates an output. For binary classification tasks, this output is typically produced using a sigmoid function, which squashes the output to a value between 0 and 1, representing the probability of the positive class. For multi-class classification tasks, a softmax function is used instead. The softmax function normalizes the output into a probability distribution over multiple classes, ensuring that the sum of probabilities across all classes equals 1.

Finally, the system can combine the outputs from both the gray and green data processors in a combined output 122. This combination can be performed in various ways, depending on the specific requirements of the prediction task. The combination methods can include simple concatenation of the outputs, weighted averaging where the weights may be learned during training or set as fixed hyperparameters, or a separate neural network layer that learns to optimally combine the two outputs. The combined output 122 represents the final prediction or classification result of the system 100.

During the training phase, the entire system can be trained end-to-end using backpropagation. In some implementations, the loss function for the overall system combines the losses from both the green and gray pathways, expressed as L_{Total}=L_{Green}+L_{Gray}, where=L_{Green} is typically a standard prediction loss (e.g., cross-entropy for classification tasks), and L_{Gray} is the combined loss described earlier.

The training process can include several stages. In the exploration stage, for a set number of epochs, all data is routed through both green and gray pathways. This allows the gating layer to learn which instances benefit from feature enrichment. In the exploitation stage, after the initial exploration phase, the gating layer's decisions can be used to route data exclusively through either the green or gray pathway. Finally, in the fine-tuning stage, the entire system can make final adjustments to optimize overall performance.

During inference, new data instances can first be processed by the gating layer, which can determine whether they should follow the green or gray pathway. The appropriate processor can then generate a prediction, which can be combined with any other pathway outputs to produce the final result.

The system's architecture allows for efficient handling of heterogeneous data, where some instances may require additional feature engineering while others can be accurately predicted using the original feature set. This adaptive approach can lead to improved prediction accuracy, especially in domains where feature quality varies across different data subsets. Moreover, the system's modular design allows for easy adaptation to different types of prediction tasks. The adaptive intelligence layers can be customized with different neural network architectures (e.g., convolutional layers for image data, recurrent layers for sequential data) while maintaining the overall functional operation of the system.

In network environments, this system can be deployed to handle the diverse data streams from various network elements and services. It processes data from well-monitored areas of the network alongside data from segments with limited visibility, such as remote sites or legacy equipment. The system automatically determines which network metrics require enrichment and generates synthetic features to fill these gaps. For instance, it may create estimated performance indicators for network paths where direct measurements are unavailable. The adaptive intelligence layers can be tailored to specific network topologies or service types, allowing for specialized analysis of different network domains such as access networks, core infrastructure, or cloud-based services. This approach enables network operators to gain a more comprehensive view of their network's performance, even in areas with limited monitoring capabilities, and can assist in tasks such as capacity planning, fault prediction, and service quality optimization across heterogeneous network infrastructures.

In summary, FIG. 1 depicts a comprehensive system for adaptive feature enrichment and prediction, combining techniques from deep learning, feature synthesis, and ensemble methods to address the challenge of variable feature quality in machine learning tasks. The system's ability to dynamically route data through appropriate processing pathways and generate synthetic features when necessary makes it a powerful tool for improving prediction accuracy across a wide range of applications and data types.

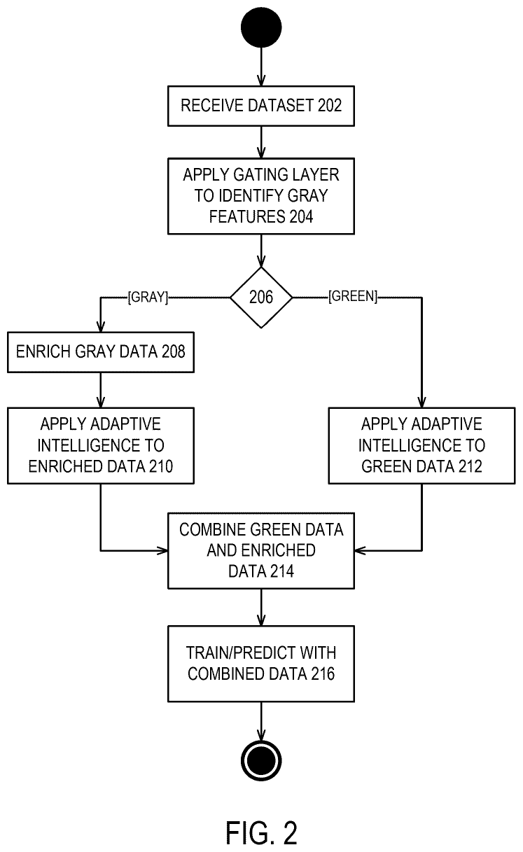

FIG. 2 is a flow diagram illustrating a method for enriching feature data using the adaptive transformation orthogonal modeling system.

In step 202, the method may include receiving an input dataset.

In some implementations, this step involves the ingestion of the input data into the system. The dataset typically consists of a collection of instances, each characterized by a set of features and, in the case of supervised learning tasks, associated target variables. The features may be numerical, categorical, or a mix of both, depending on the specific problem domain. The system is designed to handle various data types, including structured data (e.g., tabular data), unstructured data (e.g., text), or semi-structured data (e.g., JavaScript Object Notation, JSON, formats).

In a network context, this input data might include a diverse array of network performance metrics and attributes. For example, each instance could represent a specific network element or connection, with features such as latency, throughput, packet loss rate, and device type. Target variables might include binary classifications like “normal” or “anomalous” network behavior, or continuous variables such as predicted bandwidth utilization. The data could come from various sources within the network, including router logs, application-level performance metrics, etc., presenting a heterogeneous dataset that reflects the network environments.

In step 204, the method may include applying a gating operation on the input data set to identify gray features.

In this step, the gating mechanism can employ a learned model (described in connection with FIG. 1) to analyze each instance in the dataset and determine whether the existing features are sufficient for accurate prediction (green instances) or if additional feature enrichment is required (gray instances). The gating model can be implemented as a neural network, decision tree, or any other suitable machine learning model capable of binary classification. As illustrated, its input is the original feature set, and its output is a binary decision for each instance. The specific architecture of the gating model can be tailored to the nature of the input data and the complexity of the classification task as discussed previously. In a network management scenario, the gating mechanism might assess the completeness and reliability of data from various network elements. For instance, data from a core router with comprehensive monitoring capabilities might be classified as “green,” requiring no further enrichment. Conversely, data from a network element with limited telemetry might be classified as “gray,” indicating a need for feature enrichment. The gating model could consider factors such as the number of available metrics, the freshness of the data, and the historical reliability of the reporting device when making these classifications.

In step 206, the method may include analyzing the output of the gating mechanism to route gray and green instances.

For instances classified as gray (i.e., benefitting from feature enrichment), the process proceeds to step 208. In this step 208, the method may include enriching those data instances marked as gray instances.

In some implementations, step 208 can correspond to the operation of the synthetic feature enricher and feature enrichment components described in FIG. 1. In some implementations, the enrichment process can include several sub-steps. First, it can generate synthetic features using a generative model, G(X, Noise), where X represents the original features and Noise is a random input to introduce variability. Then, it can evaluate the generated features using the combined loss function: L_{Gray}=λ₁*Corr(X, G(X, Noise))+λ₂*H(p, q). Finally, it can perform iterative refinement of the synthetic features through backpropagation to minimize the loss function. The generative model G can be implemented as a neural network with an architecture suitable for the input data type. For instance, it might be a multilayer perceptron for tabular data or a convolutional neural network for image data. In a network environment, these synthetic features may include estimated packet loss rates derived from throughput and latency measurements, inferred link utilization based on traffic patterns and known link capacities, or predicted peak hour performance metrics generated from limited time-series data. The synthetic feature enricher may also create synthetic quality of service (QoS) indicators by combining multiple lower-level metrics, or estimate end-to-end performance characteristics for paths where only partial route information is available.

After enrichment, the method can proceed to step 210 where it applies an adaptive intelligence operation to the enriched data. In some implementations, this step 210 can include passing the enriched data (i.e., original features concatenated with synthetic features) through an adaptive intelligence layer, as described in FIG. 1. In some implementations, this layer can include multiple neural network layers (e.g., dense layers, convolutional layers, or recurrent layers, depending on the data type), a mixture of experts (MoE) component, which allows for specialized processing of different types of inputs, activation functions (e.g., ReLU, tanh) between layers, and regularization techniques such as dropout or L2 regularization to prevent overfitting. The adaptive intelligence layer learns to extract high-level features from the enriched data and map them to the target variable. In some implementations, the adaptive intelligence layer can learn complex relationships between various network metrics, both original and synthetic. For instance, it can identify patterns in how different types of network traffic affect latency and throughput across various network segments. The mixture of experts component could specialize in different aspects of network behavior, such as one expert focusing on core network performance, another on edge device behavior, and a third on application-layer performance. This layered approach allows the system to capture both broad network-wide patterns and specific, localized behaviors that might be unique to certain network elements or configurations.

Returning to step 206, for instances classified as green, the process proceeds to step 212. In this step 212, the method may include applying a second adaptive intelligence operation on the green data instances. This step is similar to step 210 but operates on the original, unenriched features. The adaptive intelligence layer for green data may have a different architecture or learned parameters compared to the one used for gray data, as it needs to work effectively with the original feature set.

As illustrated, the outputs of step 212 and step 210 are combined in step 214, where the method may include combining the processed green and enriched gray data.

In some implementations, the combination can be performed in several ways, including simple concatenation of the outputs from both pathways, weighted sum of the outputs, with weights either fixed or learned during training, or a separate neural network layer that learns to optimally combine the two outputs. The choice of combination method depends on the specific requirements of the task and can be determined through experimentation and validation.

In step 216, the method may include training and/or predicting using the combined data. As will be described in more detail, the step can vary depending on whether the system is in training or inference mode. During training, the combined output can be compared to the true target values, and a loss function (e.g., cross-entropy for classification, mean squared error for regression) can be computed. The error can then be backpropagated through the entire system, including both green and gray pathways, the gating layer, and the feature enrichment components. Model parameters can be updated using an optimization algorithm such as stochastic gradient descent (SGD) or Adam. This process can be repeated for multiple epochs until convergence or a predefined stopping criterion is met. During inference (i.e., prediction), the combined output represents the final prediction or classification for new, unseen instances. No parameter updates are performed and the trained model is used to generate predictions.

As discussed, the training process for the system can include multiple phases. The initial exploration phase can include passing all data through both green and gray pathways to train the gating layer. This can be followed by an exploitation phase where the gating layer's decisions are used to route data exclusively through either the green or gray pathway. Finally, a fine-tuning phase can be performed where the entire system is jointly optimized.

The method of FIG. 2 allows for efficient handling of heterogeneous data where some instances benefit from additional feature engineering while others can be accurately processed using the original feature set. This adaptive approach can lead to improved prediction accuracy, especially in domains where feature quality or relevance varies across different subsets of the data. Moreover, the modular nature of the process allows for easy adaptation to different types of prediction tasks and data types. The adaptive intelligence layers and feature enrichment components can be customized with different architectures while reutilizing the system architecture, making it a versatile approach for a wide range of machine learning applications.

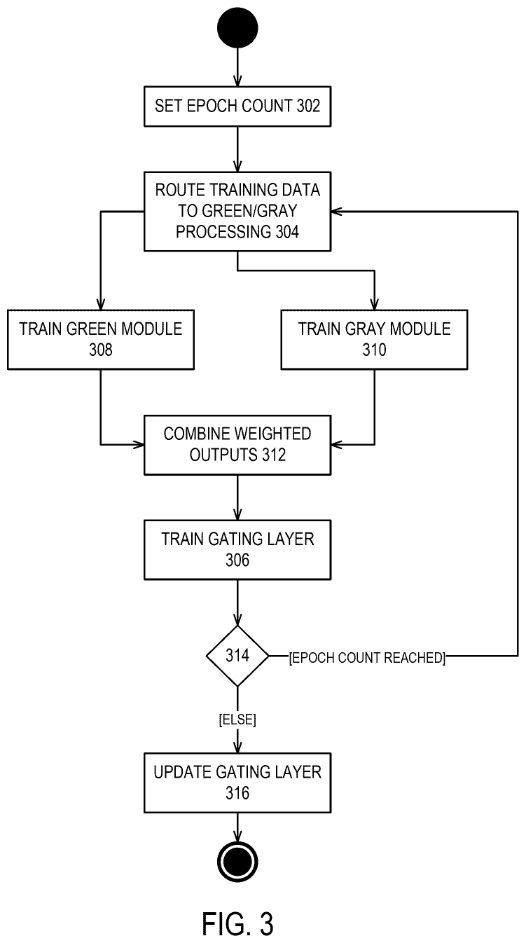

FIG. 3 is a flow diagram illustrating training phase exploration method of the adaptive transformation orthogonal modeling system. The following method illustrates how the system initially learns to distinguish between data instances that require feature enrichment and those that can be processed with the original feature set.

In step 302, the method may include setting an epoch count.

In some implementations, this step can include determining the number of epochs for which the exploration phase will run. In some implementations, the epoch count is a hyperparameter that influences how long the system will spend learning to categorize data instances before moving to the exploitation phase. The optimal number of epochs can vary depending on the complexity of the dataset and the difficulty of the classification task.

Following the epoch count setting, the method proceeds to step 304 where it can include routing training data to green and gray processing. During this exploration phase, all training data instances may be sent through both the green and gray processing pathways. This dual routing can allow the system to learn which instances benefit from feature enrichment (gray pathway) and which can be accurately processed with the original features (green pathway).

In step 308, the method may include training the green module. The green module, which operates on the original feature set, may be trained to maximize prediction accuracy without feature enrichment. This training process typically involves feeding the original features through the green module's neural network architecture, computing the prediction error, and then using backpropagation to adjust the network's weights and biases. The objective function for the green module focuses solely on minimizing the prediction error, as it does not involve any feature enrichment. The green module may employ various neural network architectures, such as fully connected layers, convolutional layers, or recurrent layers, depending on the nature of the input data. Regularization techniques like dropout or L2 regularization may also be applied to prevent overfitting.

Concurrently, in step 310, the method may include training the gray module. The gray module may include both the feature enrichment component and the subsequent processing layers. Its training may involve optimizing the synthetic feature generation as well as the processing of the enriched feature set. The feature enrichment component, typically implemented as a generative neural network, learns to create synthetic features that complement the original features. The processing layers of the gray module then learn to effectively utilize both the original and synthetic features for prediction.

The training of the gray module can generally balance two objectives: creating synthetic features that are orthogonal to the original features (to provide new information) and ensuring these synthetic features are relevant to the prediction task. This can be achieved through a specialized loss function, for example: L_{Gray}=λ₁*Corr(X, G(X, Noise))+λ₂*H(p, q). In this function, Corr(X, G(X, Noise)) represents the correlation between the original features X and the generated features G(X, Noise), which is minimized to ensure orthogonality. H(p, q) represents the prediction error, typically implemented as cross-entropy for classification tasks or mean squared error for regression tasks. The hyperparameters λ₁ and λ₂ control the balance between these two objectives and may be adjusted based on the specific requirements of the task.

In step 312, the method may include combining weighted outputs. This step represents the process of merging the results from the green and gray modules. During the exploration phase, this combination helps in comparing the performance of both pathways for each instance. The weights used in this combination may be fixed or learned parameters, and they can play a crucial role in determining how much influence each pathway has on the final output during this phase. The combination could be implemented as a simple weighted average, for example, where the weights are initially set to 0.5 for each pathway and then adjusted based on their relative performance. Alternatively, a more sophisticated combination method could be employed, such as a small neural network that learns to optimally combine the outputs based on the input features.

Following the combination of outputs, in step 306, the method may include training the gating layer. This step represents the process of updating the gating layer's parameters based on the relative performance of both pathways. The gating layer, which may be implemented as a neural network, learns to predict whether a given instance should be classified as green or gray. This learning process can involve comparing the combined outputs of the green and gray pathways for each instance and adjusting the gating layer's parameters to improve its decision-making accuracy. The gating layer's objective function could be formulated as a binary classification task, where the “correct” classification for each instance is determined by which pathway (green or gray) produced the more accurate prediction. Techniques such as gradient descent with backpropagation can be used to update the gating layer's parameters.

The method then proceeds to step 314, where it can include determining whether the epoch count has been reached. This step checks whether the predefined number of exploration epochs has been completed. An epoch typically represents one complete pass through the entire training dataset. The number of epochs is a hyperparameter that balances between sufficient learning and avoiding overfitting. This check ensures that the exploration phase continues for the designated number of iterations, allowing the system to gather comprehensive information about the performance of both pathways across multiple passes through the data.

If the epoch count has not been reached, the method can return to step 304, continuing the exploration phase with the next batch of training data. This looping process ensures that the system continues to refine its understanding of which instances benefit from feature enrichment and which do not, across multiple passes through the dataset. Each iteration provides additional opportunities for the green module, gray module, and gating layer to improve their respective performances.

If the epoch count has been reached, the method can proceed to step 316, where it can include updating the gating layer. This final step in the exploration phase involves a comprehensive update of the gating layer based on the accumulated learning from all exploration epochs. The gating layer's parameters can be fine-tuned to optimize its ability to route future instances to the appropriate processing pathway. This update may involve techniques such as batch normalization to stabilize the learned parameters, or it may incorporate the results of a final evaluation on a held-out validation set to ensure the gating layer generalizes well to unseen data.

After executing the method of FIG. 3, the system can transition to the exploitation phase, where the trained gating layer is used to route each instance to either the green or gray pathway exclusively. In the exploitation phase, the system leverages the knowledge gained during exploration to efficiently process new data instances, applying feature enrichment only when necessary as determined by the now-trained gating layer.

The weighted combination of outputs during this phase serves multiple purposes. It allows for a direct comparison of the performance of the green and gray pathways for each instance, providing valuable information for training the gating layer. Additionally, it helps in gradually transitioning the system from a state where both pathways contribute to every prediction to a state where the gating layer makes a definitive choice between pathways. The iterative nature of the exploration phase, controlled by the epoch count, allows for fine-tuning of all system components. With each epoch, the gating layer's decisions become more refined, the feature enrichment process in the gray module becomes more effective, and both the green and gray modules become better at processing their respective inputs.

In the context of network performance prediction, the training phase exploration might proceed as follows: initially, an epoch count is set (step 302), determining how many times the system will process the entire network dataset. The system then routes all network data instances through both green and gray pathways (step 304). For example, data from a core router might be processed both with and without feature enrichment. In parallel, the green module (step 308) is trained on the original network metrics (like latency, throughput, and packet loss), while the gray module (step 310) learns to generate and utilize synthetic features (such as estimated link utilization or predicted peak hour performance). These modules' outputs are combined (step 312), allowing the system to compare which approach better predicts network performance for each device or segment. Based on this comparison, the gating layer is trained (step 306) to recognize which network elements benefit from feature enrichment. For instance, it might learn that data from edge routers with limited monitoring capabilities consistently benefits from enrichment, while data from well-instrumented data center switches does not. This process repeats for the set number of epochs (step 314), with the gating layer continuously refining its decision-making. Once complete, the gating layer receives a final update (step 316), preparing it to efficiently route future network data instances in the exploitation phase.

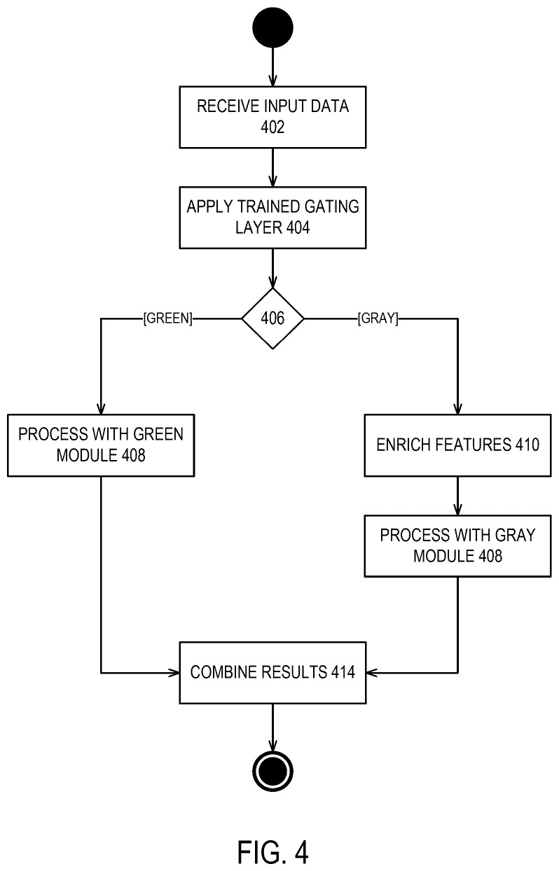

FIG. 4 is a flow diagram illustrating training phase exploitation and inferencing method of the adaptive transformation orthogonal modeling system.

In step 402, the method may include receiving input data. This step involves the ingestion of data instances into the system. During the exploitation phase of training, these would be training data instances, while during inference, these would be new, unseen data instances for which predictions are required.

In step 404, the method may include applying the trained gating layer. This step utilizes the gating layer that was trained during the exploration phase (as shown in FIG. 3). The gating layer, typically implemented as a neural network, analyzes each input instance and determines whether it should be processed through the green or gray pathway. This decision is based on the gating layer's learned understanding of which instances benefit from feature enrichment and which can be accurately processed using only the original features. Details of training a gating layer are provided in FIG. 3.

In step 406, the method may include a decision point where the path splits based on the gating layer's output. In some implementations, the decision is binary: each instance is classified as either “green” or “gray.” Although, as discussed, the specific label is not limiting.

For instances classified as “green,” in step 408, the method may include processing in the green module. The green module operates on the original feature set without any enrichment. It typically consists of an adaptive intelligence layer, which may include multiple neural network layers, activation functions, and possibly a mixture of experts component. The green module is optimized to extract maximum information from the original features and map them directly to the target variable.

For instances classified as “gray,” in step 410, the method may include enriching features. This step corresponds to the operation of the synthetic feature enricher described in FIG. 1. The feature enrichment process involves generating synthetic features that are both orthogonal to the original features and relevant to the prediction task. This is achieved through a generative model, G(X, Noise), where X represents the original features and Noise is a random input to introduce variability. The synthetic features are optimized using the specialized loss function: L_{Gray}=λ₁*Corr(X, G(X, Noise))+λ₂*H(p, q), which balances feature orthogonality and target relevance, as discussed above.

After feature enrichment, in step 412, the method may include processing in the gray module. The gray module operates on the enriched feature set, which combines the original features with the newly generated synthetic features. Like the green module, the gray module typically consists of an adaptive intelligence layer, but it may have a different architecture or learned parameters to effectively process the enriched feature set.

In step 414, the method may include combining results. This step integrates the outputs from both processing modules. The combination method can vary depending on the specific implementation and may include concatenation of the outputs from the active pathway (either green or gray), a weighted sum of both pathway outputs, where the weights are determined by the gating layer's confidence in its decision, or a separate neural network layer that learns to optimally combine the outputs when both pathways are utilized.

The exploitation and inferencing process, as depicted in FIG. 4, represents the operational phase of the System where it leverages its learned adaptive capabilities. This phase differs from the exploration phase in several aspects. Unlike the exploration phase where all instances are processed through both pathways, in this phase, each instance is processed through only one pathway as determined by the gating layer. This leads to more efficient computation and resource utilization. The gating layer's decisions in this phase are typically more confident and refined, having been trained through multiple epochs in the exploration phase. Each pathway (green and gray) has been optimized for its specific type of input, original features for the green pathway and enriched features for the gray pathway. This specialization allows for more effective processing of each instance type. For instances routed through the gray pathway, the feature enrichment process has been optimized to generate synthetic features that are most likely to improve prediction accuracy for that specific type of instance.

During the exploitation phase of training, the system can continue to learn and refine its parameters, but with each instance following only one pathway. This allows for fine-tuning of the entire system under conditions that more closely resemble the final operational mode. In some implementations, the gating layer, in particular, may continue to be updated based on the relative performance of each pathway for the instances it routes. In some implementations, in the inferencing mode, the system may operate in a fully deterministic manner, with no further updates to the model parameters. The gating layer makes routing decisions, and either the green or gray module processes each instance to produce the final prediction or classification.

In the context of network performance prediction, the exploitation and inference phase might operate as follows: first, the system receives input data (step 402), which could be real-time network telemetry from various devices. For each network element or data point, the trained gating layer is applied (step 404). For instance, data from a well-monitored core router might be classified as “green” (step 406), leading directly to processing in the green module (step 408) using only its original metrics like throughput, latency, and packet loss. Conversely, data from a network element with limited monitoring capabilities might be classified as “gray,” triggering the feature enrichment process (step 410). Here, synthetic features could be generated, such as estimated link utilization based on partial traffic data, or predicted performance metrics for unmeasured network segments. This enriched data is then processed by the gray module (step 412), which is specifically trained to handle these augmented feature sets. Finally, the results from both pathways are combined (step 414), producing a comprehensive network performance prediction that leverages both direct measurements and synthetically enriched data. This approach allows the system to provide accurate predictions across the entire network, even in areas with limited observability, enabling more effective network management and optimization.

The system's ability to dynamically route instances and selectively apply feature enrichment allows it to adapt to heterogeneous datasets where some instances benefit from additional synthetic features while others do not. This adaptive approach can lead to improved overall prediction accuracy compared to static models that treat all instances uniformly. Moreover, the system's modular design, as illustrated in FIG. 4, allows for easy adaptation to different types of prediction tasks and data types. The gating layer, feature enrichment process, and processing modules can all be customized or replaced with different architectures. This flexibility makes the system applicable to a wide range of machine learning tasks across various domains.

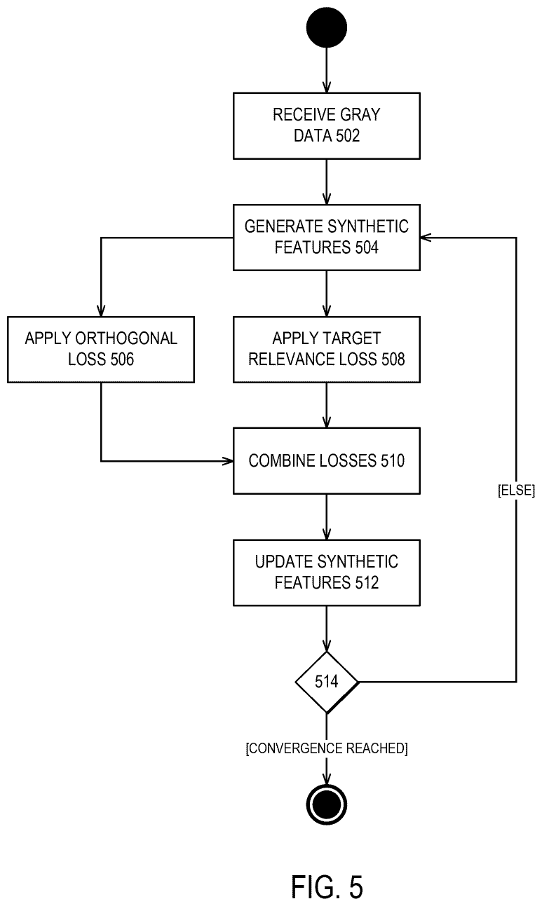

FIG. 5 is a flow diagram illustrating the feature enrichment process within the adaptive transformation orthogonal modeling system. The method is responsible for generating synthetic features that enhance the predictive power of the model for instances classified as “gray” by the gating layer. The feature enrichment process is designed to create new features that are both orthogonal to the original feature set and highly relevant to the prediction task at hand.

In step 502, the method can include receiving gray data. This step involves the ingestion of data instances that have been classified by the gating layer as requiring feature enrichment. These instances are typically those for which the original feature set is deemed insufficient for accurate prediction.

Following the reception of gray data, in step 504, the method can include generating synthetic features. This step may involve the use of a generative model, e.g., implemented as a neural network. The generative model, denoted as G(X, Noise), takes two inputs: the original features X and a noise component. The inclusion of noise helps in creating diverse and non-deterministic synthetic features, which is useful for capturing a wide range of potential informative patterns.

In some implementations, the architecture of the generative model can vary depending on the nature of the input data and the specific requirements of the task. For tabular data, it might be implemented as a multilayer perceptron with several hidden layers. For image data, it could take the form of a convolutional neural network. In general, the model should be capable of generating features that have the potential to complement the original feature set in meaningful ways.

Once the synthetic features are generated, the method bifurcates into two parallel evaluation steps. In step 506, the method can including applying an orthogonal loss, and in step 508 the method can include applying a target relevance loss. These two steps represent the dual objectives of the feature enrichment process, as described more herein.

In step 506, the method can include applying orthogonal loss. This step focuses on ensuring that the generated synthetic features are as uncorrelated as possible with the original features. This is included as the goal of feature enrichment is to provide new, complementary information rather than redundant data. The orthogonal loss is typically computed as a correlation measure between the original features X and the generated features G(X, Noise). By minimizing this correlation, the system encourages the creation of features that capture information not present in the original feature set.

Concurrently, in step 508, the method can include applying target relevance loss. This step evaluates how well the synthetic features contribute to predicting the target variable. This ensures that the new features are not just different from the original ones, but also useful for the prediction task. The target relevance loss is often implemented as a standard prediction loss function, such as cross-entropy for classification tasks or mean squared error for regression tasks. It measures how well the combined set of original and synthetic features predicts the target variable.

In step 510, the method can include combining losses. This step integrates the orthogonal loss and the target relevance loss into a single, composite loss function. The combined loss can be expressed as a weighted sum: L_{Gray}=λ₁*Corr(X, G(X, Noise))+λ₂*H(p, q), where Corr represents the correlation (orthogonal loss), H represents the prediction error (target relevance loss), and λ₁ and λ₂ are hyperparameters that control the balance between these two objectives. The setting of these hyperparameters may require tuning based on the specific characteristics of the dataset and the prediction task.

Following the loss combination, in step 512, the method can include updating synthetic features. This step involves using the computed loss to update the parameters of the generative model through backpropagation. The goal is to adjust the model so that it produces synthetic features that better satisfy the dual objectives of orthogonality and target relevance. This update process typically uses an optimization algorithm such as stochastic gradient descent (SGD) or Adam to minimize the combined loss.

In step 514, the method can include determining whether convergence has been reached. This step evaluates whether the feature enrichment process has achieved a satisfactory level of performance. Convergence can be determined based on various criteria, such as the stability of the loss function over multiple iterations, the magnitude of parameter updates, or a predetermined maximum number of iterations. If convergence has not been reached, the method can return to step 504, initiating another round of synthetic feature generation and evaluation. If convergence is achieved, the method can terminate, signifying the completion of the feature enrichment process for the current data instance or batch.

The iterative nature of this process allows for the progressive refinement of the synthetic features. With each iteration, the generative model becomes better at producing features that are both distinct from the original features and useful for prediction. This adaptive approach enables the system to tailor its feature enrichment process to the specific characteristics of each dataset and prediction task. By dynamically generating synthetic features for instances where the original features are insufficient, the system can adapt to varying data quality and relevance across different subsets of the data. This adaptability is particularly valuable in domains where the predictive power of features may vary significantly across different segments of the population or different conditions. Moreover, the dual-objective optimization in the feature enrichment process addresses a technical challenge in feature engineering: the trade-off between adding new information and maintaining relevance to the prediction task. By explicitly balancing these objectives through the combined loss function, the system can generate synthetic features that genuinely enhance the model's predictive power without introducing unnecessary complexity or noise.

In the context of network performance prediction, the feature enrichment process might operate as follows: first, the system receives “gray” data (step 502), such as partial network metrics from a network element with limited monitoring capabilities. In step 504, the system generates synthetic features using a neural network-based generative model. For instance, it might create estimated bandwidth utilization based on sporadic traffic samples, or infer potential bottleneck points from partial routing information. The system then evaluates these synthetic features in two ways: it applies an orthogonal loss (step 506) to ensure the new features aren't simply replicating existing information, such as checking that the estimated bandwidth utilization isn't simply a rescaled version of packet count. Concurrently, it applies a target relevance loss (step 508) to ensure the synthetic features are useful for predicting network performance. These losses are combined (step 510) to guide the feature generation process. The system then updates the synthetic features (step 512) based on this combined loss, perhaps refining the estimated bandwidth utilization to better correlate with actual performance issues. This process iterates until convergence (step 514).

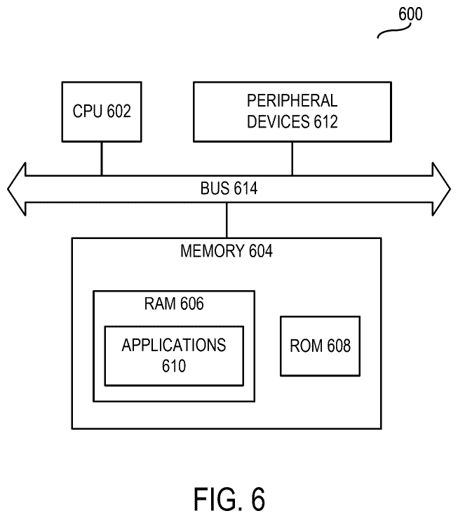

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

1. A method comprising:
receiving a dataset comprising a plurality of instances;
applying a gating layer to each instance to generate a first set of instances and second set of instances;
generating synthetic features for the first set of instances using a feature enrichment process to generate enriched instances and processing the enriched instances using a first adaptive intelligence layer;
processing the second set of instances using a second adaptive intelligence layer;
combining outputs from the first adaptive intelligence layer and the second adaptive intelligence layer to generate a combined dataset; and
generating a predictive output based on the combined dataset.

2. The method of claim 1, further comprising training the gating layer by: setting an epoch count for an exploration phase; classifying a set of enriched features and a set of non-enriched features during the exploration phase; and updating the gating layer based on the set of enriched features and the set of non-enriched features.

3. The method of claim 1, wherein processing instances using the first adaptive intelligence layer or second adaptive intelligence layer comprises: receiving input features; applying a series of deep learning layers to the input features; and generating an output using one of a sigmoid function for binary classification or a softmax function for multi-class classification.

4. The method of claim 1, wherein generating synthetic features comprises:
iteratively generating synthetic features using a generative model;
evaluating the synthetic features using a combined loss function, wherein the combined loss function measures orthogonality to original features and relevance to a target variable; and
updating the generative model until a convergence criterion is met.

5. The method of claim 4, wherein the combined loss function comprises: a first term measuring a correlation between original features and generated synthetic features; a second term measuring a prediction error using the generated synthetic features; and weighting the first term and second term.

6. The method of claim 1, further comprising: dynamically adjusting the gating layer during operation based on performance of instances processed with and without feature enrichment.

7. The method of claim 1, wherein the gating layer is implemented as a binary classifier, and wherein parameters of the gating layer are updated using backpropagation based on a performance difference between the first adaptive intelligence layer and second adaptive intelligence layer.

8. A non-transitory computer-readable storage medium for tangibly storing computer program instructions capable of being executed by a computer processor, the computer program instructions defining steps of:
receiving a dataset comprising a plurality of instances;
applying a gating layer to each instance to generate a first set of instances and second set of instances;
generating synthetic features for the first set of instances using a feature enrichment process to generate enriched instances and processing the enriched instances using a first adaptive intelligence layer;
processing the second set of instances using a second adaptive intelligence layer;
combining outputs from the first adaptive intelligence layer and the second adaptive intelligence layer to generate a combined dataset; and
generating a predictive output based on the combined dataset.

9. The non-transitory computer-readable storage medium of claim 8, the steps further comprising training the gating layer by: setting an epoch count for an exploration phase; classifying a set of enriched features and a set of non-enriched features during the exploration phase; and updating the gating layer based on the set of enriched features and the set of non-enriched features.

10. The non-transitory computer-readable storage medium of claim 8, wherein processing instances using the first adaptive intelligence layer or second adaptive intelligence layer comprises: receiving input features; applying a series of deep learning layers to the input features; and generating an output using one of a sigmoid function for binary classification or a softmax function for multi-class classification.

11. The non-transitory computer-readable storage medium of claim 8, wherein generating synthetic features comprises:
iteratively generating synthetic features using a generative model;
evaluating the synthetic features using a combined loss function, wherein the combined loss function measures orthogonality to original features and relevance to a target variable; and
updating the generative model until a convergence criterion is met.

12. The non-transitory computer-readable storage medium of claim 11, wherein the combined loss function comprises: a first term measuring a correlation between original features and generated synthetic features; a second term measuring a prediction error using the generated synthetic features; and weighting the first term and second term.

13. The non-transitory computer-readable storage medium of claim 8, the steps further comprising: dynamically adjusting the gating layer during operation based on performance of instances processed with and without feature enrichment.

14. The non-transitory computer-readable storage medium of claim 8, wherein the gating layer is implemented as a binary classifier, and wherein parameters of the gating layer are updated using backpropagation based on a performance difference between the first adaptive intelligence layer and second adaptive intelligence layer.

15. A device comprising:
a processor configured to:
receive a dataset comprising a plurality of instances;
apply a gating layer to each instance to generate a first set of instances and second set of instances;
generate synthetic features for the first set of instances using a feature enrichment process to generate enriched instances and processing the enriched instances using a first adaptive intelligence layer;
process the second set of instances using a second adaptive intelligence layer;
combine outputs from the first adaptive intelligence layer and the second adaptive intelligence layer to generate a combined dataset; and
generate a predictive output based on the combined dataset.

16. The device of claim 15, the processor further configured to train the gating layer by: setting an epoch count for an exploration phase; classify a set of enriched features and a set of non-enriched features during the exploration phase; and update the gating layer based on the set of enriched features and the set of non-enriched features.

17. The device of claim 15, wherein processing instances using the first adaptive intelligence layer or second adaptive intelligence layer comprises: receiving input features; applying a series of deep learning layers to the input features; and generating an output using one of a sigmoid function for binary classification or a softmax function for multi-class classification.

18. The device of claim 15, wherein generating synthetic features comprises:
iteratively generating synthetic features using a generative model;
evaluating the synthetic features using a combined loss function, wherein the combined loss function measures orthogonality to original features and relevance to a target variable; and
updating the generative model until a convergence criterion is met.

19. The device of claim 15, wherein the combined loss function comprises: a first term measuring a correlation between original features and generated synthetic features; a second term measuring a prediction error using the generated synthetic features; and weighting the first term and second term.

20. The device of claim 15, the processor further configured to dynamically adjusting the gating layer during operation based on performance of instances processed with and without feature enrichment.
